(19) United States
(12) Patent Application Publication
(10) Pub. No.: US 2026/0319219 A1
(43) Pub. Date: Oct. 15, 2026

(54) LENS, OPTICAL APPARATUS, IMAGE PICKUP APPARATUS, ELECTRONIC DEVICE, METHOD OF MANUFACTURING LENS, AND DIE

(71) Applicant: CANON KABUSHIKI KAISHA, Tokyo (JP)

(72) Inventors: YUTA ITAHASHI, Saitama (JP); SHUSUKE TOBITA, Kanagawa (JP)

(21) Appl. No.: 19/466,700

(22) Filed: Feb. 2, 2026

(30) Foreign Application Priority Data
Feb. 17, 2025 (JP) 2025-023301

(51) Int. Cl. G02B 13/00; B29D 11/00; G02B 1/04; B29K 23/00

(52) U.S. Cl. CPC G02B 13/0025; B29D 11/00009; G02B 1/041; B29K 2023/38

(57) ABSTRACT

Provided is a lens containing a resin, wherein the lens comprises a lens surface having a shape which includes a curved surface on a central portion of the lens, and an inflection point on an outer side of the central portion, and wherein the lens surface is rougher at a position of the inflection point than the curved surface on the central portion.

### BACKGROUND

### Field of the Technology

The present disclosure relates to a lens, an optical apparatus, an image pickup apparatus, an electronic device, a method of manufacturing a lens, and a die.

### Description of the Related Art

In recent years, smartphone optical systems have been trending toward larger sensor sizes, and, in order to suppress aberration, the number of lenses has been continuously increasing. When the number of lenses is increased while thicknesses of the lenses remain the same as those of related-art lenses, a protruding amount of a lens unit from a smartphone main body becomes larger.

Meanwhile, with further thinning of the lenses in the future, manufacturing lenses by conventional injection molding is expected to become difficult. Thus, a manufacturing method other than injection molding is required.

In Japanese Patent Laid-Open No. 2005-511367, it is disclosed that a preform of a thermoplastic resin is prepared and is then subjected to pressing to form a lens.

In International Publication No. WO00/012291, it is disclosed that a lens is manufactured by pressing using a thermoplastic resin sheet.

### SUMMARY

The present disclosure is directed to providing a lens without any appearance defects with high precision.

In order to solve the problems described above, there is provided a lens containing a resin, wherein the lens includes a lens surface having a shape which includes a curved surface on a central portion of the lens, and an inflection point on an outer side of the central portion, and wherein the lens surface is rougher at a position of the inflection point than the curved surface on the central portion. Further, there is also provided an optical apparatus including: an optical system including the above-mentioned lens; and a casing configured to enclose the optical system. Further, there is also provided an image pickup apparatus including: an optical system including the above-mentioned lens; and an image pickup element configured to receive light that has passed through the optical system. Further, there is also provided an electronic device including: an optical system including the above-mentioned lens; an image pickup element configured to receive light that has passed through the optical system; and a display element configured to display an image that has been captured by the image pickup element. Further, there is also provided an electronic device including: an optical system including the above-mentioned lens; an image pickup element configured to receive light that has passed through the optical system; and a light emitting element configured to illuminate a target to be imaged.

Further, there is also provided a method of manufacturing a lens, the method including: preparing a sheet containing a resin; and forming the sheet into a lens shape by pressing the sheet with a die, wherein, during the forming, after a first portion of the sheet, which corresponds to a central portion of the lens, is pressed with the die, a second portion of the sheet, which corresponds to an outer side of the central portion, is pressed with the die. In addition, there is also provided a die for pressing a sheet containing a resin to form the sheet into a lens shape, the die including: a portion for pressing a first portion of the sheet, which corresponds to a central portion of the lens; and a portion for pressing a second portion of the sheet, which corresponds to an outer side of the central portion, wherein the portion for pressing the first portion of the sheet is formed so as to protrude beyond the portion for pressing the second portion of the sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of sheet forming using a related-art configuration.

FIG. 2 is a schematic view for illustrating an example of a lens according to the present disclosure.

FIG. 3A is a schematic view for illustrating a state before start of the forming of the sheet forming in the first embodiment of the present disclosure.

FIG. 3B is a schematic view for illustrating an initial part of the forming of the sheet forming in the first embodiment of the present disclosure.

FIG. 3C is a schematic view for illustrating an intermediate part of the forming of the sheet forming in the first embodiment of the present disclosure.

FIG. 3D is a schematic view for illustrating a final part of the forming of the sheet forming in the first embodiment of the present disclosure.

FIG. 4A is a schematic view for illustrating a state before start of the forming of the sheet forming in the first embodiment of the present disclosure.

FIG. 4B is a schematic view for illustrating an initial part of the separating in the sheet forming in the first embodiment of the present disclosure.

FIG. 4C is a schematic view for illustrating a final part of the separating in the sheet forming in the first embodiment of the present disclosure.

FIG. 5A is a schematic view for illustrating a state before start of the forming of the sheet forming in the second embodiment of the present disclosure.

FIG. 5B is a schematic view for illustrating an intermediate part of the forming of the sheet forming in the second embodiment of the present disclosure.

FIG. 5C is a schematic view for illustrating a final part of the forming of the sheet forming in the second embodiment of the present disclosure.

### DESCRIPTION OF THE EMBODIMENTS

Hereinafter, embodiments for carrying out the present disclosure are described with reference to the accompanying drawings. However, the embodiments described below are merely exemplary embodiments of the present disclosure, and the present disclosure is not limited thereto. Common configurations are described with reference to a plurality of the drawings at the same time, and description of configurations denoted by the same reference symbols is omitted as appropriate. Different items with the same designation can be distinguished from one another by adding ordinal numbers to the item name, for example, "a first item", "a second item" and so on.

When a lens having a concave surface with a large aperture angle and a large thickness variation, for example, a lens that is found in a smartphone optical system, is to be manufactured by pressing a sheet, wrinkle-like appearance defects may occur due to inhibition of elongation of the sheet at its central portion.

In configurations disclosed in Japanese Patent Laid Open No. 2005-511367 and International Publication No. WO00/012291, a thin lens can be manufactured by press forming. However, the formation of wrinkles cannot be suppressed for lenses, in particular, lenses having a concave surface with a large aperture angle and a large thickness variation.

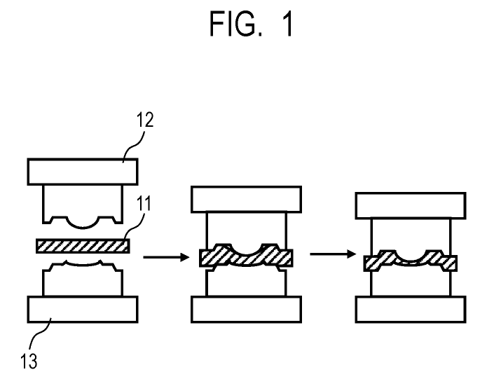

A method of manufacturing a lens based on related-art sheet forming is described with reference to FIG. 1. A sheet 11 of a thermoplastic resin is placed between an upper die 12 and a lower die 13, which have been heated. The upper die 12 is driven so that the sheet 11 is sandwiched between the upper die 12 and the lower die 13. The sheet 11 is plastically deformed by pressing under heating. After cooling is performed, the sheet 11 is released from the dies. The dies are heated with, for example, a heater, and cooling is performed by causing cooling water to pass through the dies after the heater is turned off. This method enables a desired lens shape to be formed in accordance with the die. However, elongation occurs in portions in which the sheet 11 interferes with the die, resulting in formation of wrinkles in the sheet 11 at a position in which elongated portions meet. The present disclosure is directed to suppressing the formation of wrinkles to provide a lens without any appearance defects.

### Embodiments

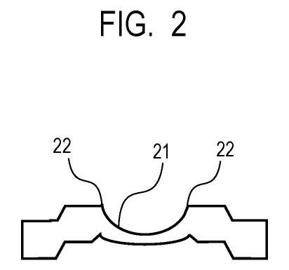

A lens according to the present disclosure is a lens containing a resin. The lens has the following features. The lens includes a lens surface having a shape which includes a curved surface on a central portion of the lens and an inflection point on an outer side of the central portion. The lens surface is rougher at a position of the inflection point than the curved surface on the central portion. FIG. 2 is a sectional view for illustrating an example of the lens according to the present disclosure. A central portion 21 has a curved surface (concave surface), and inflection points 22 lie on an outer side of the central portion 21. In the embodiments described herein, the inflection point is defined as a point at which a sign of a curvature of the lens surface changes (including a point at which the sign changes from positive to negative, from positive to 0, and from negative to 0). In the embodiments described herein, the central portion of the lens serves as an optical portion (optical effective region). However, the central portion and the optical portion are not always required to completely match each other, and are only required to match each other to the extent that the effects of the present disclosure are obtained.

The method of manufacturing a lens according to the present disclosure includes: preparing a sheet containing a resin; and forming the sheet into a lens shape by pressing the sheet with a die. During the forming, after a first portion of the sheet, which corresponds to the central portion of the lens, is pressed with the die, a second portion of the sheet, which corresponds to an outer side of the central portion, is pressed with the die.

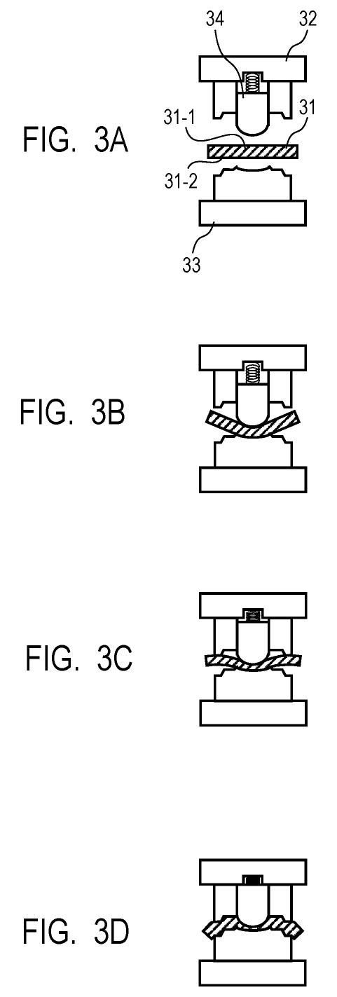

Press forming for a lens in a first embodiment is described with reference to FIGS. 3A-3D. First, as the preparing, a sheet containing a resin is prepared. FIGS. 3A-3D are schematic views for illustrating a sheet 31 of a thermoplastic resin, which is placed between an upper die 32 and a lower die 33. As a material for the sheet 31, for example, a cycloolefin-based resin can be used. Besides the thermoplastic resin, the sheet 31 may be made of any material being deformable by pressing with a die, such as a thermosetting resin, which has required optical characteristics.

A die for pressing the sheet 31 includes: a portion for pressing a first portion 31-1 of the sheet 31, which corresponds to the central portion of the lens; and a portion for pressing a second portion 31-2 of the sheet 31, which corresponds to an outer side of the central portion of the lens. The die can be configured so that the portion for pressing the first portion 31-1 of the sheet 31 protrudes beyond the portion for pressing the second portion 31-2 of the sheet 31. Further, the portion for pressing the first portion 31-1 of the sheet 31 can be configured so that a protruding amount thereof decreases as pressing proceeds. Further, the portion for pressing the first portion of the sheet 31 can be held through intermediation of an elastic body. The use of the die as described above enables effective forming without separating pressing the first portion and pressing the second portion. In this embodiment, an insert 34 for forming the central portion of the lens is connected to the upper die 32 through intermediation of a spring therebetween. The upper die 32 and the lower die 33 are in a state of being heated with, for example, a heater.

Prior to start of the forming, the spring is in an extended state as illustrated in FIG. 3A. Thus, during the forming, the insert 34 is first brought into contact with the sheet 31 along with downward movement of the upper die 32 as illustrated in FIG. 3B. After that, as the spring is progressively compressed, the upper die 32 is progressively moved downward as illustrated in FIG. 3C. As a result, the upper die 32 is brought into contact with the second portion of the sheet 31, which corresponds to a region on the outer side of the first portion. Finally, when the insert 34 is in contact with the upper die 32 as illustrated in FIG. 3D, the movement of the insert 34, which has been caused by the spring, is stopped. As a result, a desired lens shape is obtained. After the forming, cooling is performed by causing cooling water to pass through the die so that the sheet is released from the die.

In related-art press forming, when elongation of the first portion of the sheet, which corresponds to the optical portion, is inhibited by elongation of the second portion of the sheet, which corresponds to a non-optical portion located on the outer side of the optical portion, there arises a risk of wrinkling the first portion of the sheet. In this embodiment, the insert 34 first presses the sheet 31, and hence the elongation of the first portion 31-1 of the sheet 31 is not inhibited. Even when the elongation occurs in the second portion 31-2 on the outer side of the first portion 31-1 and interferes with the elongation that has occurred, wrinkles are formed in the second portion 31-2. That is, the forming can be performed while the wrinkles formed in the first portion 31-1 are being stretched out toward the second portion. In this manner, the lens having a lens surface that is rougher at the position of the inflection point than at the central portion can be obtained.

This method is particularly advantageous when, for example, a shape with the central portion having a concave surface as the curved surface is to be formed. For example, a lens shape corresponding to a lens having a central portion with a concave surface and a thickness of 0.3 mm or less at the central portion can be formed. Further, when a lens to be formed includes a central portion having a convex surface, the above-mentioned method is particularly advantageous in forming, for example, a sheet having a convex surface into a lens shape having a gentler convex surface (with a smaller curvature).

A size of the lens is not limited to any particular size. The use of the present disclosure enables a small-size lens to be precisely formed. The size of the lens can be set to, for example, a diameter of 10 mm or more and 20 mm or less. As a shape of the lens, the thickness of the lens at the central portion can be set smaller than the thickness of the lens at the position on the outer side of the central portion (for example, at the position of the inflection point). Further, as the thickness, the thickness of the lens at the central portion can be set to 0.3 mm or less.

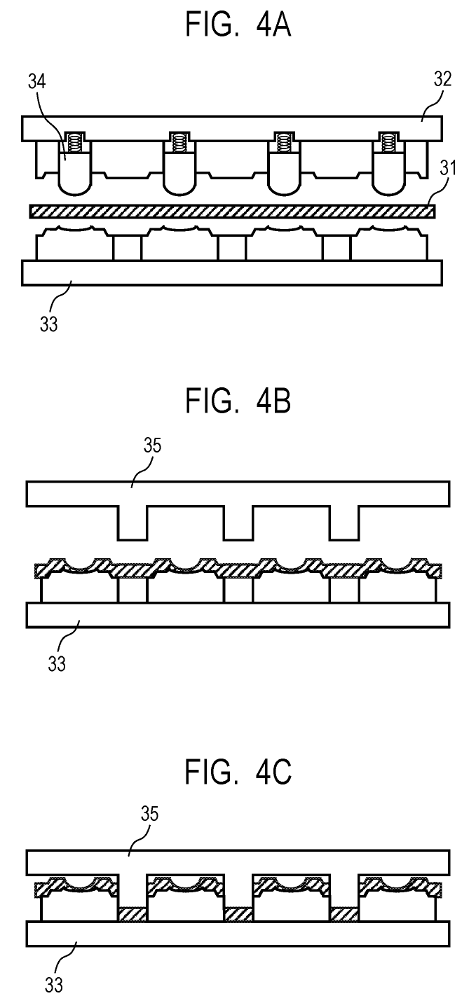

Further, the method may further include separating the sheet into pieces each having a lens shape after the forming. As illustrated in FIG. 4A, a plurality of inserts 34 are provided, and the upper die 32 and the lower die 33 are each formed so as to have an integrated structure to thereby form a large number of lenses at one time. After the upper die 32 is moved upward and the sheet 31 is released from the die, a punching die 35 having a structure for cutting the sheet 31 is arranged in place of the upper die 32 so as to be opposed to the lower die 33 as illustrated in FIG. 4B, and is moved downward as illustrated in FIG. 4C to thereby separate the sheet into pieces each having a lens shape. A cut mark may remain after the separation, and thus the lens may have a projecting shape at its outer peripheral end over the entire circumference.

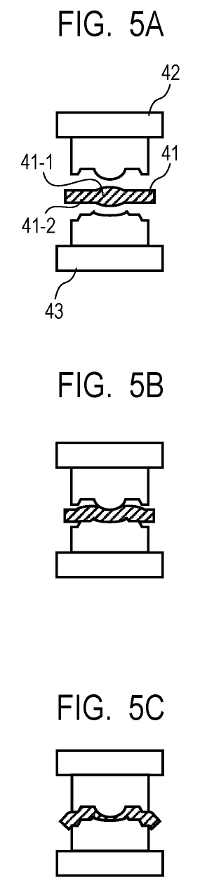

Next, press forming for a lens in a second embodiment is described with reference to FIGS. 5A-5C. A sheet 41 that is used in this embodiment has a larger thickness at a first portion 41-1 corresponding to an optical portion (central portion) than at a portion (a second portion 41-2) on an outer side thereof as illustrated in FIG. 5A. After the sheet 41 is sandwiched between an upper die 42 and a lower die 43 as illustrated in FIG. 5B, the upper die 42 is progressively moved downward. Then, the first portion 41-1 of the sheet 41 is first pressed with the upper die 42. The upper die 42 is further progressively moved downward to thereby form a desired lens shape as illustrated in FIG. 5C. In this embodiment, the first portion of the sheet is first pressed with the die for forming the central portion (optical portion) of the lens. Thus, elongation of the sheet expands to the second portion. As a result, as in the first embodiment, wrinkles are prevented from being formed in the central portion of the lens.

Other configurations and effects are the same as those of the first embodiment.

An optical apparatus can be configured by enclosing an optical system including the lens according to the present disclosure in a casing. Further, an image pickup apparatus can be configured by combining the optical system including the lens according to the present disclosure and an image pickup element configured to receive light that has passed through the optical system. Further, an electronic device such as a smartphone can be configured by combining the optical system including the lens according to the present disclosure, the image pickup element configured to receive light that has passed through the optical system, and a display element configured to display an image captured by the image pickup element. Further, an electronic device such as an endoscope can be configured by combining the optical system including the lens according to the present disclosure, the image pickup element configured to receive light that has passed through the optical system, and a light emitting element configured to illuminate a target to be imaged.

The present disclosure is not limited to the embodiments described above, and many modifications may be performed within the technical idea of the present disclosure. In addition, the effects described in the embodiments are merely examples of the most suitable effect arising from the present disclosure, and the effects according to the present disclosure are not limited to those described in the embodiments.

The embodiments described above can be changed as appropriate without departing from the technical idea. For example, a plurality of embodiments can be combined. Further, a matter of a part of at least one embodiment can be deleted or replaced.

Further, a new matter can be added to at least one embodiment. Contents disclosed in this specification include not only contents explicitly described in this specification but also all matters that can be grasped from this specification and the drawings attached to this specification.

According to the present disclosure, it is possible to provide a lens without any appearance defects with high precision.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023301, filed February 17, 2025, which is hereby incorporated by reference herein in its entirety.

What is claimed is:

1. A lens containing a resin,
wherein the lens comprises a lens surface having a shape which includes a curved surface on a central portion of the lens, and an inflection point on an outer side of the central portion, and
wherein the lens surface is rougher at a position of the inflection point than the curved surface on the central portion.

2. The lens according to claim 1, wherein the curved surface on the central portion is a concave surface.

3. The lens according to claim 1, wherein the lens has a projecting shape at an outer peripheral end over an entire circumference.

4. The lens according to claim 1, wherein the resin is a thermoplastic resin.

5. The lens according to claim 1, wherein a thickness of the lens at the central portion is smaller than a thickness of the lens at a position of the inflection point.

6. The lens according to claim 1, wherein a thickness of the lens at the central portion is 0.3 mm or less.

7. The lens according to claim 1, wherein the resin is a cycloolefin-based resin.

8. An optical apparatus comprising:
an optical system including the lens of claim 1; and
a casing configured to enclose the optical system.

9. An image pickup apparatus comprising:
an optical system including the lens of claim 1; and
an image pickup element configured to receive light that has passed through the optical system.

10. An electronic device comprising:
an optical system including the lens of claim 1;
an image pickup element configured to receive light that has passed through the optical system; and
a display element configured to display an image that has been captured by the image pickup element.

11. An electronic device comprising:
an optical system including the lens of claim 1;
an image pickup element configured to receive light that has passed through the optical system; and
a light emitting element configured to illuminate a target to be imaged.

12. A method of manufacturing a lens, the method comprising:
preparing a sheet containing a resin; and
forming the sheet into a lens shape by pressing the sheet with a die,
wherein, during the forming, after a first portion of the sheet, which corresponds to a central portion of the lens, is pressed with the die, a second portion of the sheet, which corresponds to an outer side of the central portion, is pressed with the die.

13. The method of manufacturing a lens according to claim 12, wherein the forming is performed while the sheet is being heated.

14. The method of manufacturing a lens according to claim 12, wherein, during the forming, the sheet is formed into such a shape that a thickness of the lens at the central portion is smaller than a thickness of the lens at a position on an outer side of the central portion.

15. The method of manufacturing a lens according to claim 12, wherein, during the forming, the lens shape corresponds to the lens having the central portion with a concave surface and a thickness of 0.3 mm or less at the central portion.

16. The method of manufacturing a lens according to claim 12, further comprising separating the sheet into pieces each having the lens shape after the forming.

17. A die for pressing a sheet containing a resin to form the sheet into a lens shape, the die comprising:
a portion for pressing a first portion of the sheet, which corresponds to a central portion of the lens; and
a portion for pressing a second portion of the sheet, which corresponds to an outer side of the central portion,
wherein the portion for pressing the first portion of the sheet is formed so as to protrude beyond the portion for pressing the second portion of the sheet.

18. The die according to claim 17, wherein the portion for pressing the first portion of the sheet is formed so that a protruding amount decreases as pressing proceeds.

19. The die according to claim 18, wherein the portion for pressing the first portion of the sheet is held through intermediation of an elastic body.
